(19) United States
(12) Patent Application Publication
(10) Pub. No.: US 2010/0254606 A1
(43) Pub. Date: Oct. 7, 2010

(54) METHOD OF RECOGNIZING TEXT INFORMATION FROM A VECTOR/RASTER IMAGE

(75) Inventors: Anton Masalovitch, Moscow (RU); Sergey Kuznetsov, Dolgoprudny (RU); Dmitri Deriaguine, Moscow (RU)

Correspondence Address: HAHN AND MOODLEY, LLP, 548 Market Street, ECM#33955, San Francisco, CA, 94104, US

(73) Assignee: ABBYY SOFTWARE LTD, Nicosia (CY)

(21) Appl. No.: 12/816,307

(22) Filed: Jun. 15, 2010

Related U.S. Application Data
(63) Continuation-in-part of application No. 11/428,845, filed on Jul. 6, 2006.

(30) Foreign Application Priority Data
Dec. 8, 2005 (RU) 2005138164A1

(51) Int. Cl. G06K 9/34

(52) U.S. Cl. 382/176

(57) ABSTRACT

A method is claimed for processing a vector-raster image file which contains a text image. The method comprises the steps of: fragmenting the image to obtain regions containing non-separable, logically connected fragments of text of the maximum possible size; processing text, vector, and raster objects; discarding excessive information; analyzing each object with the help of all available information. The step of processing text objects includes the steps of: dividing into separate characters and character groups according to supposed locations of blank spaces or other non-indicated symbols, and analyzing and assembling character groups into words and verifying and correcting characters encoding based on recognition of assembled words as raster objects. The step of processing vector objects includes the step of identifying separators, background, and substrates of blocks. The step of processing raster objects includes the steps of: analyzing non-text objects on order to detect text images within them, and/or detecting vector objects other than separators.

This application is a continuation-in-part of U.S. Ser. No. 11/428,845 filed on Jul. 6, 2006.

### FIELD OF THE INVENTION

Embodiments of the present invention relate to pattern recognition

### BACKGROUND

Images of a document may be saved as an electronic image file in vector/raster format. An example of said vector/raster format includes the ubiquitous Portable Document Format (PDF). Information or data from a document in vector/raster format may be extracted using vector/raster processing techniques. However, such techniques only extract vector/raster information from the document image, without retrieval of text content from the document or information about the formatting of the document.

### SUMMARY

In one embodiment of the invention, there is provided a method that allows the extraction of content and formatting information from a vector/raster image of a document, for example, from a file in PDF format. Advantageously, the content and the formatting information is sufficient to restore the document later in the original or close to original form in any known editable format.

Embodiments of the present invention also disclose techniques to broaden the capabilities of recognizing a document from an electronic image file in vector-raster format, increasing the reliability of obtaining text, raster, and vector objects, extracting the information about the formatting of the document, and accelerating the processing.

One technique/method in accordance with the invention comprises fragmenting the image; processing text, vector, and raster objects; discarding excessive information; and analyzing each object with the help of all available information.

Processing text objects may include dividing each text object into separate characters and character groups according to supposed locations of blank spaces or other non-indicated symbols, analyzing and assembling character groups into words; and verifying and correcting characters encoding based on recognition of assembled words as raster objects.

Processing vector objects may include identifying separators, background, and substrates of blocks.

Processing raster objects may include analyzing non-text objects on order to detect text images within them, and/or detecting vector objects other than separators.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1 shows a flowchart for the method of the present invention.

FIG. 2 shows a flowchart for the method of recognizing text information on the basis of the information about a vector-raster image in electronic form, in accordance with one embodiment of the invention.

FIG. 3 shows a flowchart for the method of processing of a text object, in accordance with one embodiment of the invention.

FIG. 4 shows a flowchart for analyzing and verifying correctness of the encoding of characters, in accordance with one embodiment of the invention.

FIG. 5 shows a flowchart for recognizing words as raster objects with help of initial character, in accordance with one embodiment of the invention.

FIG. 6 shows a block diagram of hardware for a system, in accordance with one embodiment of the invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the present invention disclose a method and system for extracting content and formatting information from a document image in vector/raster format, eg. in PDF format.

The method may be implemented as a program as software e.g. as a computer program running on a system such as the system described herein, later. Alternatively, the method may be implemented as a program in firmware.

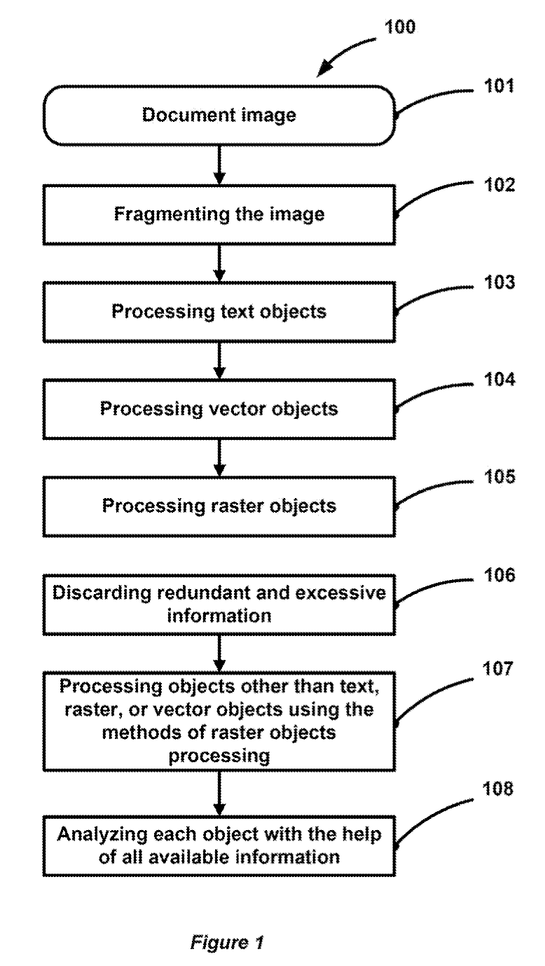

In one embodiment, the inventive method may include the steps shown in the flowchart of FIG. 1.

Referring to FIG. 1, the steps include:

fragmenting the image (102) in order to obtain regions containing non-separable, logically connected

fragments of text of the maximum possible size;

processing text objects (103);

processing vector objects (104);

processing raster objects (105);

discarding excessive information (106);

processing objects other than text, raster, or vector objects using the methods of raster objects processing (107); and

analyzing each object with the help of all available information that has been obtained as a result of the processing of other objects (108).

In one embodiment, acceleration of the processing may be achieved by excluding or reducing some commonly performed operations. For example, in many cases, the necessity to recognize a raster text is at least partially discarded.

The image is fragmented in order to obtain regions containing non-separable, logically connected fragments of text of the maximum possible size. To do this, the image is divided into regions that presumably contain text fragments, and then analyzes adjacent regions for the purpose of uniting them into greater regions.

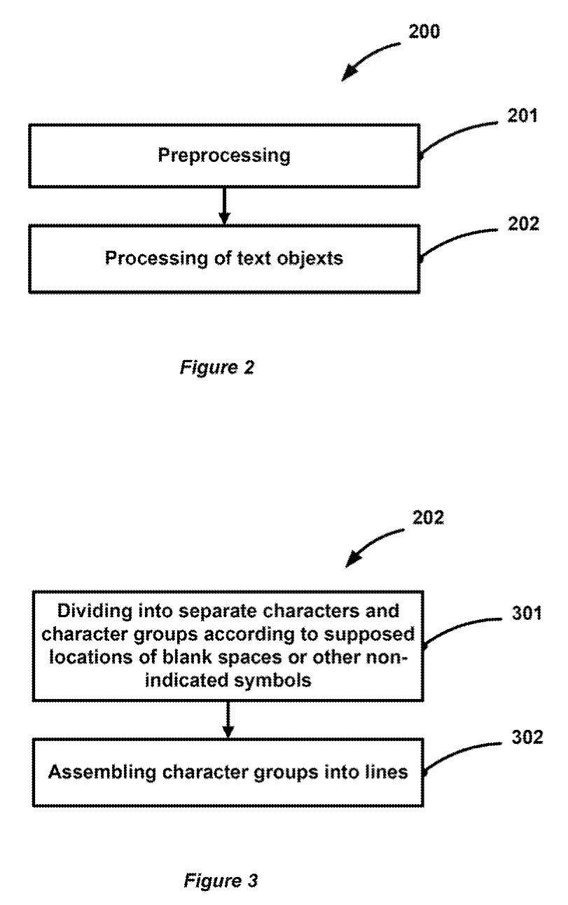

As can he seen from FIG. 2 of the drawings, the step of processing text objects (103) includes the step of preprocessing (201) and the step of processing (202) of text objects.

In one embodiment, the step of preprocessing (201) is performed prior to character recognition, and may include the operations performed using the attributes of the file formatting which are available in the vector-raster image file.

In one embodiment, the step (202) of processing the text objects may include the following steps shown in FIG. 3:

Dividing (301) each fragment into separate characters and character groups according to supposed locations of blank spaces or other non-indicated symbols, such as separators, punctuators, strokes, graphic lines, etc.; and

assembling (302) (=uniting, collecting) character groups into lines.

The step of dividing each fragment into separate characters and character groups may include at least the step of converting the absolute coordinates of characters into groups which are separated by blank spaces and enlarged inter-character intervals.

After assembling, a row is divided into words on the basis of the location of blank spaces, if any, and the analysis of inter-character intervals where there are no blank spaces is performed.

After dividing an object into rows and words, the program analyzes and verifies the correctness of the encoding of characters, and corrects it, if necessary.

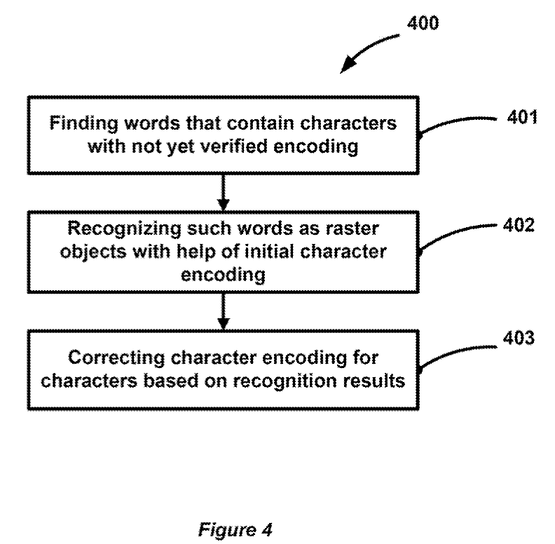

FIG. 4 shows steps of analyzing and verifying correctness of the encoding of characters, in accordance with one embodiment of the invention. Analyzing and verifying correctness of the encoding of characters includes at least steps of:

finding (401) words that contain characters with not yet verified encoding;

recognizing (402) such words as raster objects with help of initial character encoding;

correcting (403) character encoding for characters based on recognition results obtained in step (402).

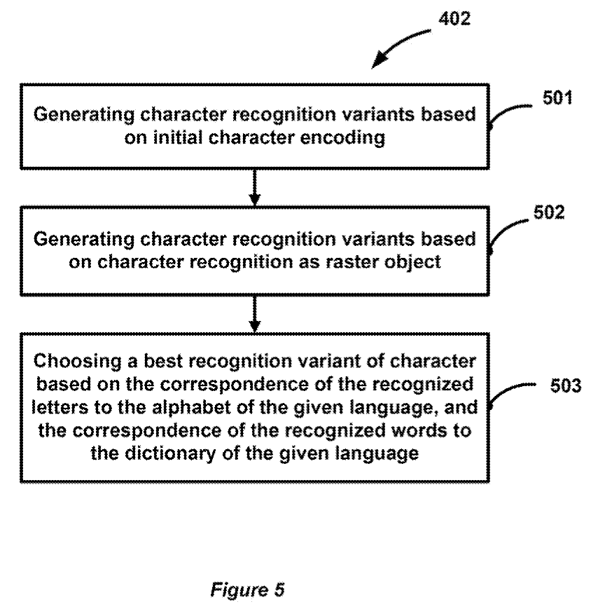

FIG. 5 shows steps of recognizing words as raster objects with help of initial character encoding, in accordance with one embodiment of the invention. Recognizing words as raster objects with help of initial character encoding includes at least steps of:

generating (501) character recognition variants based on initial character encoding;

generating (502) character recognition variants based on character recognition as raster object;

choosing (503) a best recognition variant of character based on the correspondence of the recognized letters to the alphabet of the given language, and the correspondence of the recognized words to a dictionary of the given language.

Initial character encoding is a code of a character which is contained in PDF format (or other vector/raster format). For each text object its code is registered in PDF. The problem is that the code may coincide with the real character, but sometimes may not coincide. So, at first, the variant of the character, extracted from PDF is taken as initial character encoding (501), and then the variants of character are generated (502) on the basis of recognition the symbol as a raster object.

Since many variants for each symbol may be generated (in consideration of different fonts, alphabets, characters which are rather like etc.), many variants of the word may be generated. The variants of the word are compared with morphological word forms from a dictionary of the given language, and the most verisimilar variant of the word is selected (503).

A language of a dictionary may be selected manually as parameter of recognizing or may be detected automatically by empirical way, for example, by learning.

In one embodiment, the processing of vector objects may include at least the step of identifying separators, background, and substrates of blocks.

In one embodiment, the processing of raster objects may include at least the steps of:

analyzing non-text objects in order to detect text images within them, detecting vector objects other than separators including those partially located outside the borders of the object.

Discarded redundant and excessive information may include at least the information about the shading of characters, about font, sloping, size of characters and other unnecessary attributes, and some other information depending on the peculiarities of the document. Such attributes and information is usually already known as a result of the processing performed on the vector/raster and text objects. Examples of said redundant and excessive information includes information about the shading of characters, font type, font size, and other information depending upon the peculiarities of the document.

The objects other than text, raster, or vector objects are processed using the methods of raster objects processing.

Each object is additionally analyzed with the help of all available information that has been obtained as a result of the processing of other objects. If, according to the results of the primary processing of an object, the program has obtained some information which can affect other objects, repeated analysis of these other objects is performed.

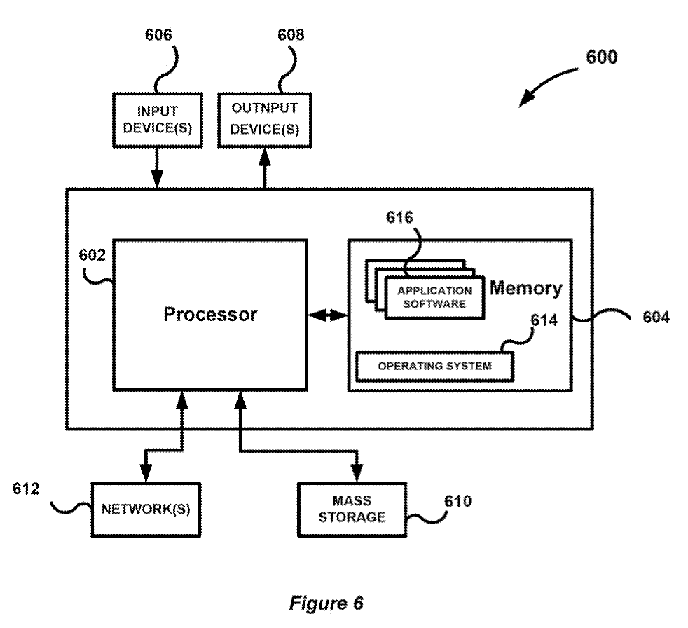

FIG. 6 of the drawings shows an example of hardware 600 that may be used to implement the system, in accordance with one embodiment of the invention. The hardware 600 typically includes at least one processor 602 coupled to a memory 604. The processor 602 may represent one or more processors (e.g., microprocessors), and the memory 604 may represent random access memory (RAM) devices comprising a main storage of the hardware 600, as well as any supplemental levels of memory, e.g., cache memories, non-volatile or back-up memories (e.g. programmable or flash memories), read-only memories, etc. In addition, the memory 604 may be considered to include memory storage physically located elsewhere in the hardware 600, e.g. any cache memory in the processor 602 as well as any storage capacity used as a virtual memory, e.g., as stored on a mass storage device 610.

The hardware 600 also typically receives a number of inputs and outputs for communicating information externally. For interface with a user or operator, the hardware 600 may include one or more user input devices 606 (e.g., a keyboard, a mouse, imaging device, scanner, etc.) and a one or more output devices 608 (e.g., a Liquid Crystal Display (LCD) panel, a sound playback device (speaker).

For additional storage, the hardware 600 may also include one or more mass storage devices 610, e.g., a floppy or other removable disk drive, a hard disk drive, a Direct Access Storage Device (DASD); an optical drive (e.g. a Compact Disk (CD) drive, a Digital Versatile Disk (DVD) drive, etc.) and/or a tape drive, among others. Furthermore, the hardware 600 may include an interface with one or more networks 612 (e.g., a local area network (LAN), a wide area network (WAN), a wireless network, and/or the Internet among others) to permit the communication of information with other computers coupled to the networks. It should be appreciated that the hardware 600 typically includes suitable analog and/or digital interfaces between the processor 602 and each of the components 604, 606, 608, and 612 as is well known in the art.

The hardware 600 operates under the control of an operating system 614, and executes various computer software applications, components, programs, objects, modules, etc. to implement the techniques described above. Moreover, various applications, components, programs, objects, etc., collectively indicated by reference 616 in FIG. 6, may also execute on one or more processors in another computer coupled to the hardware 600 via a network 612, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks, (DVDs), etc.). While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

1. A method for extracting information from a document image in vector/raster format, comprising:
fragmenting the document image in order to obtain regions containing non-separable, logically connected fragments of text of the maximum possible size;
processing text objects;
processing vector objects;
processing raster objects;
discarding excessive information;
processing objects other than text, raster, or vector objects using the methods of raster objects processing (107); and
analyzing each object with the help of all available information that has been obtained as a result of the processing of other objects (108).
